(19) United States
(12) Patent Application Publication
(10) Pub. No.: US 2010/0275118 A1
(43) Pub. Date: Oct. 28, 2010

(54) METHOD AND SYSTEM FOR USER-INTERACTIVE ITERATIVE SPELL CHECKING

(76) Inventors: Robert Iakobashvili, Ashdod (IL); Ofer Chermesh, Even Yehuda (IL); Michael Moser, Modiin (IL); Iris Kaminer, Even Yehuda (IL)

Correspondence Address: Professional Patent Solutions, P.O. BOX 654, HERZELIYA PITUACH, 46105, IL

(21) Appl. No.: 12/809,621

(22) PCT Filed: Apr. 20, 2009
(86) PCT No.: PCT/IL09/00429

§ 371 Date: Jun. 21, 2010

Related U.S. Application Data
(60) Provisional application No. 61/071,320, filed on Apr. 22, 2008.

(51) Int. Cl. G06F 17/27; G06F 3/048

(52) U.S. Cl. 715/257; 715/810

(57) ABSTRACT

The present invention provides a method of correction of misspelled, confused words and grammar errors in a text, as well as a computer system employing this method. The method of the invention is user-interactive, which means that, when implemented by a computer system, the interaction between the user and the system is employed with the aid of the user-system interface. In the method of the invention the method detects misspelled and confused words, where some of the detected confused words could be grammar errors, and provides user with the correction alternatives for each such word. In response, the user can chose an appropriate correction, mark the word as correct or require other correction alternatives. The user-system dialog, which is intended to improve the correctness of the text, is repeated until all the words-in-question are corrected or marked by the user as correct.

### TECHNICAL FIELD OF DIE INVENTION

The present invention relates to assistance in text and word processing, editing documents or any other written content, including web-content, mobile content and more specifically to spell checking.

### ABBREVIATIONS

API—application program interface;
CPU—central processing unit;
GUI—graphical user interface;
UI—user interface;

### DEFINITIONS

Phrase is a string of two or more logically connected written words being a sentence, or a part thereof;
Misspelled word is a word not belonging to a dictionary of the particular natural language, or user's personal dictionary;
Confused word (also, misused, out-of-context word, a real-word error) is a word belonging to a dictionary of a natural language, or user's personal dictionary, but used incorrectly with regards to the context of the phrase (e.g. “I want to meat you”, where the actual intention is “I want to meet you”). In some cases confused words are grammar usage errors.
Correction alternative is a word suggested for replacing misspelled or confused word;
Set of correction alternatives is a set of words each of which being a correction alternative.
Word-in-question is a misspelled, confused or suspected confused word;
Target language is a natural language of the texts to be checked and corrected;
Foreign language is any other language, such as natural language other than target language, computer programming language, etc.

### REFERENCES

1. http://en.wikipedia.org/wiki/Spell_checker#Context-sensitive_spell_checkers
2. http://www.alphaworks.ibm.com/tech/csspell
3. http://www.merl.com/projects/spelling/
4. Riseman, Edward M. & Hanson, Allen R, A contextual post-processing system for error correction using binary n-grams, IEEE Trans Computers, vol. C-23, no.5, pp480-493, May 1974.
5. Morris, Robert & Cherry, Lorinda L, Computer detection of typographical errors, IEEE Trans Professional Communication, vol. PC-18, no.1, pp54-64, March 1975.
6. Mays, Eric, Damerau, Fred J, & Mercer, Robert L, Context-based spelling correction, Information Processing and Management, vol.27, no.5, pp517-522, 1991.
7. Alberga, Cyril N, String similarity and misspellings, Communications of the A.C.M, vol.10, no.5, pp302-313, May 1967.
8. Angell, Richard C, Freund, George E, & Willett, Peter, Automatic spelling correction using a trigram similarity measure, Information Processing and Management, vol.19, no.4, pp255-261, 1983.
9. Golding, Andrew R, & Roth, Dan, A Winnow-Based Approach to Context-Sensitive Spelling Correction, Machine Learning, vol.34, no. 1-3, 1999.
10. http://wordnet.princeton.edu/

### BACKGROUND ART

Computer word processing, using computer programs commonly called text editors or word processors, is a part of most people daily lives. Many people are writing in multiple computer programs, such as documents, e-mails, instant messengers, chats, etc. People are commonly making writing mistakes, which can be pure technical mistakes, like typing a wrong letter, or mistakes originating from poor language knowledge, or deficient literacy or visual impairments disabilities like dyslexia.

Spelling correction, either automatic or explicitly requested by user, is a common event in word processing. Spellers (spelling software programs or program components, servers, hardware devices, etc) are either correcting the misspelled words or suggesting one or several correction alternatives by testing each written words against a dictionary of the known words. If a speller finds a written word, which is not in the dictionary, it tries to suggest alternative words taken from the dictionary, which are “closest” to the written word and normally differ from it in 1-2 letters. Most advanced spellers are suggesting as alternatives also words, which are very different from the misspelled words, but are pronounced very similarly, performing also so-called phonetic spell checking.

Conventional spellers fail to correct or propose the right correction, when a written word contains several mistakes, which make it too “distant” or “un-recognizable” from any word in the dictionary. This is what happens, when conventional spellers attempt to work on texts written by dyslexics, for example. Yet another problem is, when a word is spelled correctly, but the word is wrong with regards to the context of the specific sentence, being a confused word. Phonetic spellers are also not helpful and are not detecting those confused words, which are “homophones” (words pronounced similarly, however that have completely different meanings). For example, in the sentence “I would like to meat a friend” appears the word “meat” instead of “meet”, conventional spellers and spelling techniques will not recognize the “homophone” problem and will not fix it or propose any corrections.

We are calling further any misspelled word or a correctly spelled word, suspected of being used out-of-context, as a word-in-question.

In order to provide a real solution to the above problems a combination of spellers with the context meaning of the text, which is commonly known as context sensitive spelling or context spelling [1,2,3], is required.

In many texts written by dyslexic writers most of the words, if not all, in a phrase are either misspelled or confused. Quality of the results obtained by applying context-spelling method to correcting of misspelled words in the phrases with lots of errors is lower, because the words in a phrase(s) that are supposed to assist and bring a context meaning are confused or misspelled by themselves. The problem is even worst for correcting of the suspected confused words, where other words being confused by themselves, can mislead the context spelling method and bring them to a wrong direction.

Various method of disambiguation used to correct sentences with a “broken” context require heavy calculations of different possible alternatives with huge processing resources (CPU, memory) involved or non-practical time to get the results.

The present invention improves context-spelling results of any context-sensitive spelling methods by using user input in the interactive and iterative manner, where user himself helps the spelling methods in disambiguation by hinting his knowledge about the words correctness.

### SUMMARY OF INVENTION

The present invention provides a method of correction of misspelled and confused words in a text written in a natural language, as well as a computer system employing this method. The method of the invention is user-interactive, which means that, when implemented by a computer system, the interaction between the user and the system is employed with the aid of the user-system interface. In the method of the invention the system detects misspelled and confused words, where some of the detected confused words could be grammar errors, and provides the user with the correction alternatives for each such word. In response, the user can choose an appropriate correction, mark the word as correct or require other correction alternatives. The user-system dialog, which is intended to improve the correctness of the text, is repeated until all the words-in-question are corrected or marked by the user as correct.

In the method of the invention the user makes decisions with regards to correction alternatives (suggested by the system) thereby improving the context of the phrase and facilitating further text corrections employed by any context-sensitive spelling method. The method of the invention is also iterative with one and more cycles of corrections between user and spelling method until all suspected misspelled and confused words are either corrected or marked as correct by user. The method of the invention does not require any pre-training or pre-learning user-specific patterns of errors.

### DISCLOSURE OF INVENTION

The present invention provides a method of correction of misspelled and confused words in a phrase written in a natural language. The invention also provides a system employing this method. The method of the invention is user-interactive, which means that when implemented by a computer system, the interaction between the user and the system is employed with the aid of the user-system interface, which can be a either of a graphic, or a console type. Said interface can be built-in into the software application, such as web-browser, word processor, or any other text-containing application, where text correction is required. The method of the invention is also iterative with one and more cycles of corrections between user and spelling method until all suspected misspelled and confused words are either corrected or marked as correct by user.

In a preferred embodiment the method of the invention comprises the following steps (the output of each step is the input for the subsequent step):
a) User's text is inputted and then processed with any known in the art context-spelling method, e.g. n-gram-based and probabilistic approaches [4, 5, 6, 7 and 8], or Winnow-based context spelling [9]. For example, but without limiting the scope of the invention, the context spelling method can be the method described in WO 2009/040790. As a result words-in-question are detected and are marked either as “misspelled” (if the word is not in the language dictionary), or “confused” (if the word is suspected to be out-of-context, including grammar errors). Each detected and marked word-in-question is accompanied by a set of correction alternatives, wherein each alternative is optionally accompanied by the explanation of its meanings and/or usage examples.
   The input text for the spelling method deployed here can be used for example in the form of an XML code with words numbering as shown at FIG. 1a. The XML encoding has advantages compared to plain text input as it enables numbering of the words and correction alternatives and marking them by XML tags. Furthermore, also the detected (as described above) words-in-question can be marked, using XML tags, example of which is shown at FIG. 1b.
   The computer system, employing the method of the invention displays the detected words-in-question together with their correction alternatives and optional explanations on the user's screen, thus enabling him to review the results and to make a correction.
   Output: Text with the detected and marked words-in-questions, each accompanied with the set of correction alternatives, and, optionally, with the explanation of the meaning or usage example for each alternative.
b) User reviews the detected words-in-question and with regards to each of them makes a decision which can be one of the following:
   [i] Selecting appropriate alternative from the set of suggested correction alternatives and marking the word as corrected by the alternative;
   [ii] Rejecting all suggested correction alternatives, while marking the word-in-question as “incorrect” (selecting this option means that the user is not satisfied with the suggested alternatives, that none of them are considered by him as acceptable, therefore other alternatives should be generated and suggested further—see steps d) and e) herein below);
   [iii] Rejecting all suggested correction alternatives, while marking the word-in-question as “correct”. Selecting this option means that the user accepts the word in its current spelling, thereby informing the system that no correction is needed. Such decision is made in one of the following cases:
      A word-in-question is neither in the language general dictionary, nor in the user's personal dictionary, therefore the user decides to add the word to his personal dictionary, and no correction will be suggested on the further steps of the method;
      Either the particular occurrence of the word-in-question is correct, or all the occurrences of the word-in-question in the entire text are correct.
   The user's selections [i], [ii], and [iii] above can be marked by, for example, XML tagging, example of which is shown at FIG. 1c.
      In the system-user interface of the computer system employing the method of the invention the above-mention decisions [i], [ii], and [iii] are implemented as follows:
   Decision [i]: a menu or other selection option with correction alternatives option to “Select” a particular alternative;
   Decision [ii]: a menu or other selection option “No Suggestions are relevant”;
   Decision [iii]: a menu or other selection options “Add to the Dictionary”, “Ignore” (case: the particular occurrence of the word-in-question is correct) and “Ignore All” (all the occurrences of the word-in-question in the entire text are correct).
   Output: the text in which some of the words-in-question are marked to be replaced with the selected corrected alternatives, whereas other words-in-question are rejected, being marked either as “incorrect”, or “correct”.
c) The output obtained from the previous step is verified by checking whether the user has made decisions with regards to all the words-in-question, and, if not, applying one of the following:
   [i] Enforcing the user to make a decision set forth on step b)-[i] by repeating the request; the request is repeated until the decision is made for each word-in-question;
   [ii] Considering each word-in-question without decision as the step b)-[ii] decision, and marking the word appropriately (e.g. by “No suggestions are relevant”);
   [iii] Considering each word-in-question without decision as the step b) [iii] decision, and marking the word appropriately (e.g. by “Ignore”, “Ignore All” or “Add Word”);
   Output: is similar to that of step b), but user's decisions are marked for all the words-in-question.
d) The input coming from step c), where it contains step b)-[i] type of marking with selected correction alternatives, is used to correct the text by replacing the words-in-question to the alternatives. Furthermore, the input text, containing remaining b)-[ii] and b)[iii] type of marking, is processed as in a), but different in that is that the context spelling method is using b)-[ii] and b)[iii] type of marking for improving of its effectiveness and quality of the spelling results;
   Output: similar to step a), but limited only to the words-in-questions, which are still not-corrected. An example of the spelling correction output originating from step d) is presented at FIG. 1d.
e) Repeating (iterating) the steps b) to d) above unless one of the following occurs:
   All the words-in-question are corrected or marked to be considered by the user as correct;
   The remaining not-corrected words-in-question have the same set of correction alternatives as in the previous iteration and, thus, cannot satisfy the user;
   The number of iterations reaches a pre-defined threshold;
   The user decides to stop the iterative correction;
   Output: The output of step e) represents the method's decision regarding continuation of the iteration process. If the method decides to continue the iterative correction, then steps b), c) and d) are repeated. An example of the second iteration output from steps b) and d) are presented at FIG. 1e and FIG. 1f, respectively. However, user has an option to intervene and, notwithstanding the method decision, to stop the iteration process.
   The following non-limiting example, illustrates the case when at step e) the method intends to stop the iteration process. When due to any reason the method decides to stop the iterative correction, the method can use an empty suggestion XML-tagging, which means, that there are no anymore correction alternatives to suggest and, therefore, correction is accomplished (example of XML code is shown at FIG. 1f). Notwithstanding method's decision regarding stopping the iteration process, user has an option to stop it by pressing at UI button “Spelling Accomplished” (not shown).

The context spelling method used at step d) is required to be adapted to use the user-marking of types b)-[ii] and b)[iii], which is coming embedded within the corrected input text.

The words-in-question corrected by a user or marked as “correct” (implemented by the interface as “Ignore”, “Ignore All” or “Add to Dictionary”) are considered by the context spelling method as being verified by the user, and, therefore being “trusted”. Thus, a context spelling method is not required to check various context alternatives for such “trusted” word.

The words-in-question marked by the user as not correct, but without appropriate correction alternative (implemented by the interface as “No suggestions are relevant”), will be re-corrected using both the newly corrected context and the knowledge, that the previously provided to user spelling alternatives have not been accepted by user, and therefore another correction alternatives set will come instead. Yet another notification, that user may pass to context spelling method is that a word, which is not word-in-question, is a user considered incorrect word (marked as “User Suspected”).

It is known that context spelling methods are less effective and less accurate, when applied to a heavily broken context, e.g. multiple neighboring confused words. Since the method of the invention is iterative, it enables improving the context of the input text of step d) above (increased percent of correct words) from iteration to iteration, thus, facilitating the detection of words-in-question and their corrections by context spelling methods.

The context spelling method used on step d) should be adapted to employ the above mentioned user's decisions (so-called “user-guided” context spelling), that is more efficient with regards to the lower number of variants to be considered and delivers better spelling corrections as seen in the Example 1.

In a mode of the preferred embodiment there is provided on step b) an additional option to the user to correct the word-in-question from his own accord, e.g. by typewriting or manually editing (implemented by the interface as “Edit Word”). Such correction can improve the spelling of the word by bringing the word closer to the intended, but in some cases the spelling is not improved. Therefore, in this mode of the preferred embodiment the corrected word is still suspected as being incorrect, and is processed on the further steps of the method as a word-in-question by assessing the context results based both on the original word and on the edited one. Afterwards, the correction alternatives, having the highest scoring of the context spelling method at step d), are suggested for the user's review and selection.

In another mode of the preferred embodiment there is provided on step b) yet additional option to the user to correct not only words-in-question, but additionally the words, that have not been detected by the context spelling method as words-in-question (i.e. the words that were considered by the spelling method as “correct”). The user can mark such word as “user-considered incorrect”. This option can be useful because the known context spelling methods are not perfect and are liable to missing a word from being suspected as a word-in-question. In some cases, the user might suspect a word of being incorrect, but he is unable to propose an appropriate correction. Thus, this option (“User Suspected”) serves as a hint to the context spelling method to provide the user with correction alternatives.

In yet another mode of the preferred embodiment user on step b) has a further option to suggest correction words for the words that have not been detected by the context spelling method as words-in-question (implemented by the interface as “Edit Word”).

The main difference between choosing this option for a word-in-question and for a not-word-in-question is that in the latter case user not only suggests another version of spelling, but also notifies the method of the invention, that the word is suspected to be incorrect. Therefore, the context-spelling method will generate correction alternatives for this word and will suggest the alternatives to user for reviewing and decisions.

In a mode of the preferred embodiment on steps a) and d) each detected confused word is further verified on the subject, whether its first correction alternative corresponds to a logical or structural rule of the language grammar for the detected confused word. If yes, such confused word is considered as a suspected grammar error, marked differently from the confused words, which are not suspected as grammar errors, and is also depicted differently at UI. There are several common methods, like usage of grammar rules or various applications, such as WordNet [10] that might be used to reveal, whether a word is a grammar form of another word.

In another preferred embodiment the invention provides the computer system employing the method of the invention, comprising a computer or other electronic device, user-system interface, a software or a firmware implementing the method of the invention and, means to pass the communication between the user-system interface and the method's implementation program(s) or firmware. The software or firmware with the context spelling method(s) of the invention could be located at the same computer or electronic device as the user-system interface, or at another network entity, communicating via network. In a mode of this embodiment the software implementing the method of the invention is distributed between the computer or other electronic device with user-system interface and other computers/devices, wherein.

The method of the invention is illustrated by the below example, which does not limit the scope of the invention.

### Example 1

The following phrase is to be checked and corrected (target language is US English):

It is tim for all goo men to come to the ad o there counttry.

Please note, that the words “tim” (“time”), “goo” (“good”), “ad” (“aid”), “o” (“of”) and “there” (“their”) are confused, which means that the words are out of a context of the phrase, whereas the word “counttry” is a misspelled one.

Firstly, the above-mentioned phrase is encoded as XML-code (FIG. 2a) and passed as defined on step a) to processing by using the context speller method described in WO 2009/040790, generating the output containing XML-encoded alternatives with their explanations (FIG. 2b—only the XML-code for words-in-question “tim” and “o” is shown). The graphical presentation of the entire XML-code output is shown at GUI menu at FIG. 2c.

After that, at step b) the user by using a GUI menu (FIG. 2c) selects a correction alternative for each words-in-question: “tim”, “goo”, “there” and “counttry” as shown herein below. With regards to the word “o” (id=13, FIG. 2b) the set of correction alternatives is “on”, “or”, “I”, “Io”, “OE”—among them no one is acceptable, therefore the user selects “No suggestions are relevant”.

tim->time

goo->good

o->“No suggestions are relevant”

there->their

counttry->country

Since user made his decision hereby for all words-in-question detected by the method, step c) verification passed input from step b) to step d) as verified.

Further, the following data are passed for processing according to step d): the words-in-question that were replaced with the user-selected alternatives (those that were chosen) and user's selections (with markings) done according to step b) and verified for all the words-in-question according to step c). The corresponding XML code is shown at FIG. 2d.

The method according to step d) corrects the text by replacing the words-in-question with the selected alternatives, where the texts correctness is already improved although two incorrect words, namely “ad” (yet not detected as a word-in-question), and “o” still remain not corrected (these words were detected, however the correction alternatives were considered by the user as not appropriate—the words were marked with “No suggestions are relevant”).

The resulting phrase looks as follows:

It is time for all good men to come to the ad o their country.

The phrase is further processed according to step d) using the context spelling method described in WO 2009/040790 and marking up the word “o” with “No suggestions are relevant”, thereby notifying the method to deliver other correction alternatives. The output of the step d) with the new correction alternatives for the word “o” (id=13) is presented at FIG. 2e. Since at step e) an acceptable alternative has been found in the newly generated set of alternatives (for this word-in-question)—the word “of”, the iterative process is continued by progressing to step b).

Further, the user on the second iteration of step b) selects for word-in-question “o” the first alternative “o” (verified on step c)), thereby correcting as follows:

o->of

The user's selection “of” replaces “o”, and the word “of” is marked appropriately and passed as an XML-code shown at FIG. 2f.

As a result of applying step d) the method corrected the text by replacing “o” with “of”, therefore the text was further improved having only one incorrect word remained-“ad”:

The resulting phrase looks as follows:

It is time for all good men to come to the ad of their country.

Then, the phrase was processed as defined on step d) by using the context spelling method described in WO 2009/040790. Now the context spelling method succeeds to detect “ad” as a confused word due to the improved context of the text (all other words in the text are correct, suiting the text context; there are no other neighboring confused words as it was “o” at previous iteration).

The output of the step d) with the correction alternatives for the word “ad” (id=12) is shown at FIG. 2g. Since at step e) a new word-in-question was detected—“ad”, the iterative process is continued by progressing to step b).

The user at the third iteration step b) selects the first alternative and corrects “ad” to “aid” (verified at step c)), as follows:

ad->aid

Here, the user's selected alternative “aid” replaces “ad”, and the user's selection is marked and passed in the form of XML-code shown at FIG. 2h.
After finishing the step d) of the third iteration the resulting phrase looks as follows:

It is time for all good men to come to the aid of their country.

At step d) the context spelling method does not detect any words-in-question, therefore, decision making of step e) notifies the user, that the phrase correction has been accomplished (the XML code with empty words-in-questions and correction alternatives is the same as at FIG. 1f).
GUI seen by user with the correction alternatives are presented at FIG. 2i (second iteration) and FIG. 2j (third iteration), respectively.
Summary of the example: three-iteration process was applied to the phrase:

It is tim for all goo men to come to the ad o there country.

resulting in the correct phrase:

It is time for all goo men to come to the ad o there country.

It is worth noting, that an attempt to correct the same phrase with the aid of MS-Word-2007 with activated embedded context speller, leads to the following correction results:

tim->time

counttry->country.

That is, only two words “tim” and “counttry” were corrected, whereas MS-Word-2007 has failed to correct “goo” (“good”), “ad” (“aid”), “o” (“of”) and “there” (“their”).
The method of the invention correcting grammar is illustrated by the below example, which does not limit the scope of the invention.

### Example 2

### Grammar Correction

The following phrase is to be corrected (target language is US English):
The cat eat a mouse.

The word “eat” is a confused word, where it is a grammar usage error with the correct word to be either “ate” or “eats”. The method of the invention operates similar to that described in Example 1. The only difference is that on steps a) and d) each suspected confused word is further verified, if the first correction alternative suggested by the context spelling methods is a grammar form of that confused word. When the answer is positive, thus, the confused word is considered as being a suspected grammar error, thereby marking the confused as “grammar” at XML output of the steps a) and d). This is illustrated by XML-code shown at FIG. 3. The word “eat” will be colored differently at step b) UI presentation of the XML-code (e.g. in green color, if other confused words are colored in blue, not shown).

### BRIEF AND DETAILED DESCRIPTION OF THE DRAWINGS

Brief description.

FIG. 1 is an example of correcting the phrase: “Meat u at sevn occk.”.

FIG. 2 is an example of correcting the phrase: “It is tim for all goo men to come to the ad o there counttry.”

FIG. 3 is an example of XML with correction alternatives for a grammar error in the phrase: “The cat eat a mouse.”

FIG. 4 is a schema of iterative process of the method of the invention.

### DETAILED DESCRIPTION

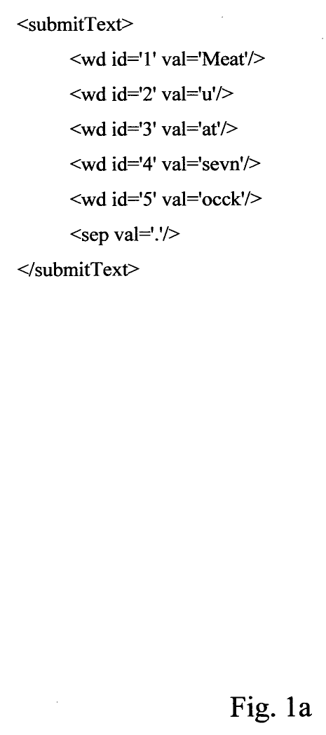

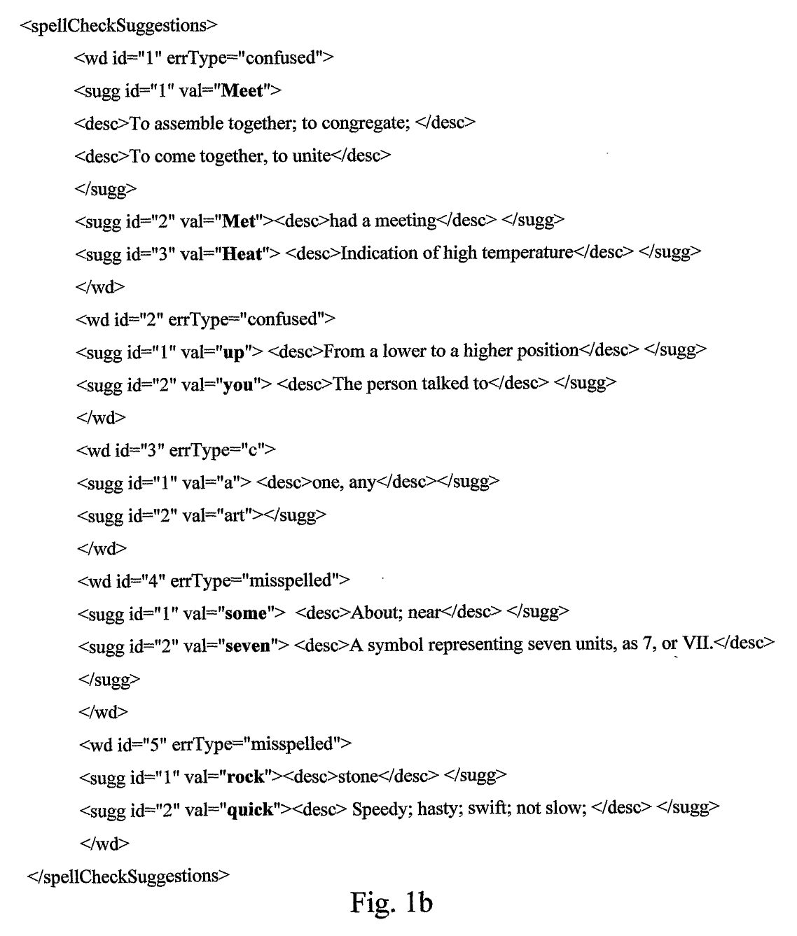

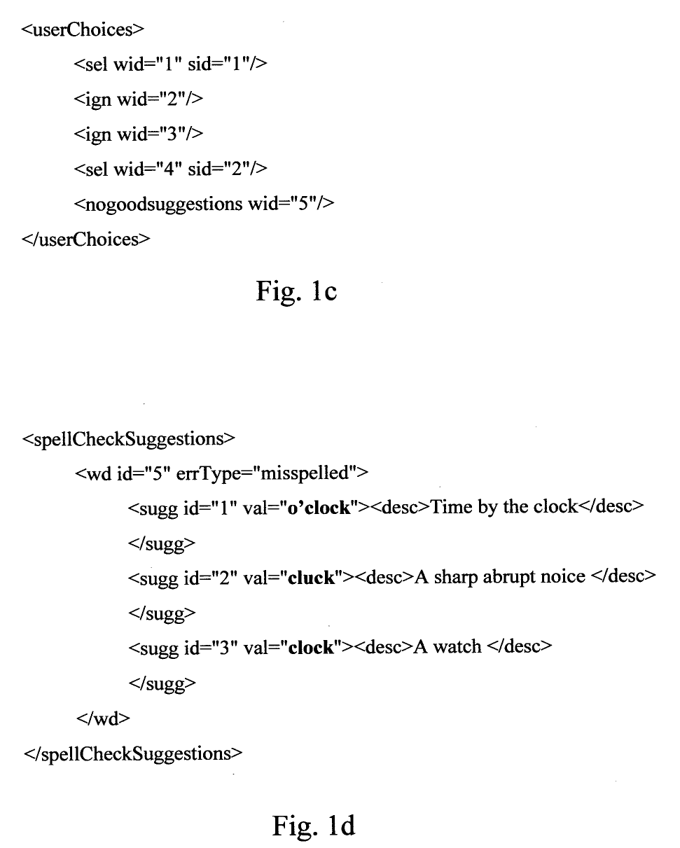

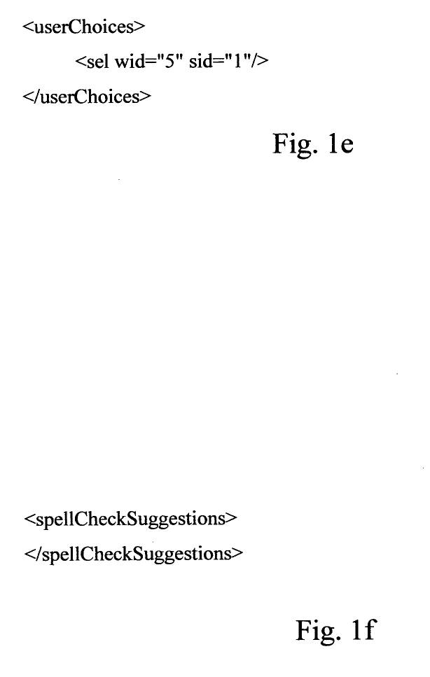

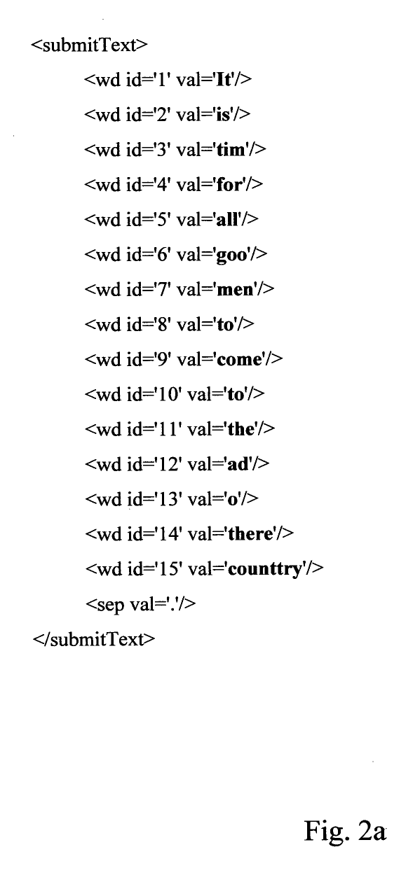

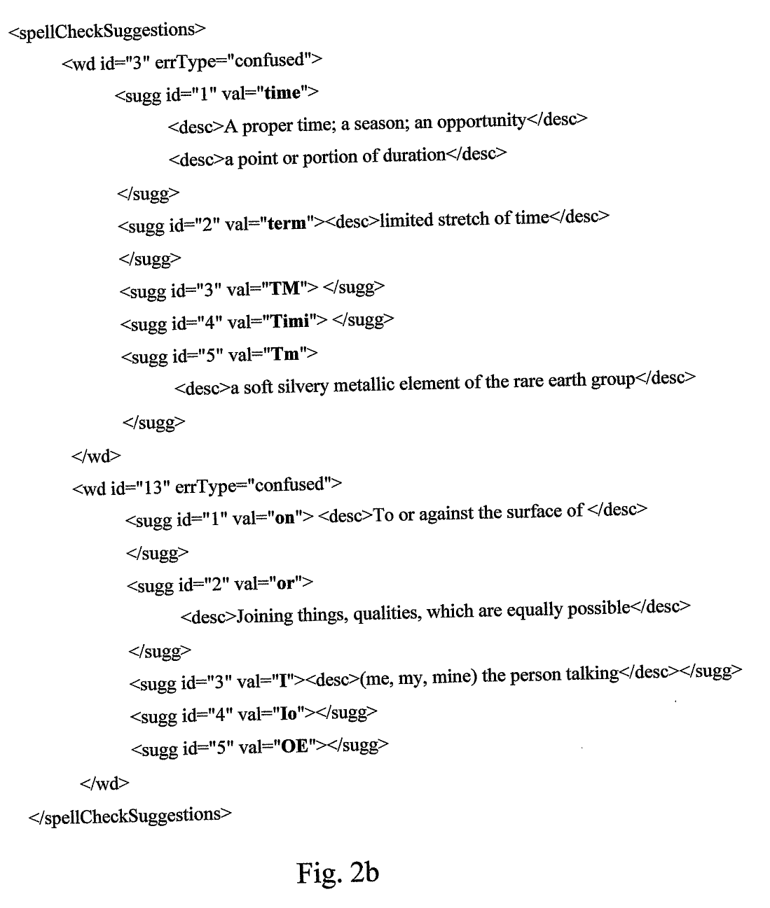

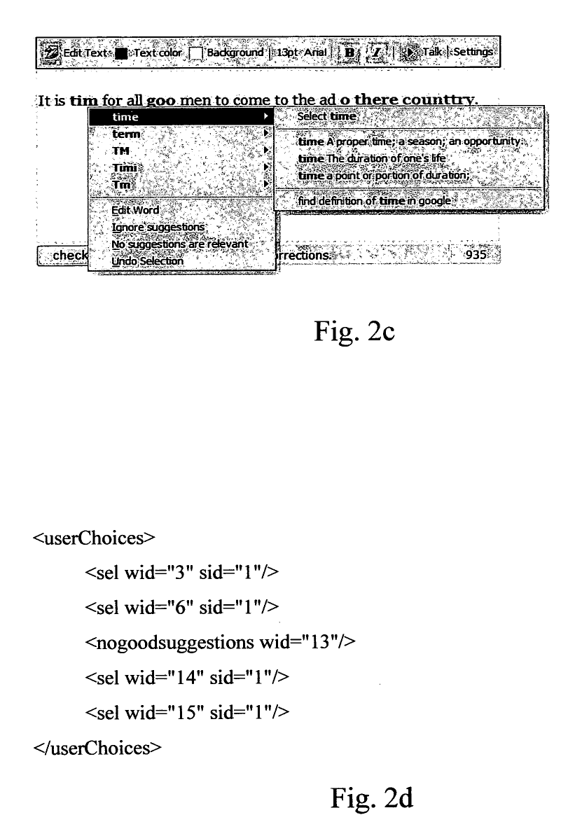

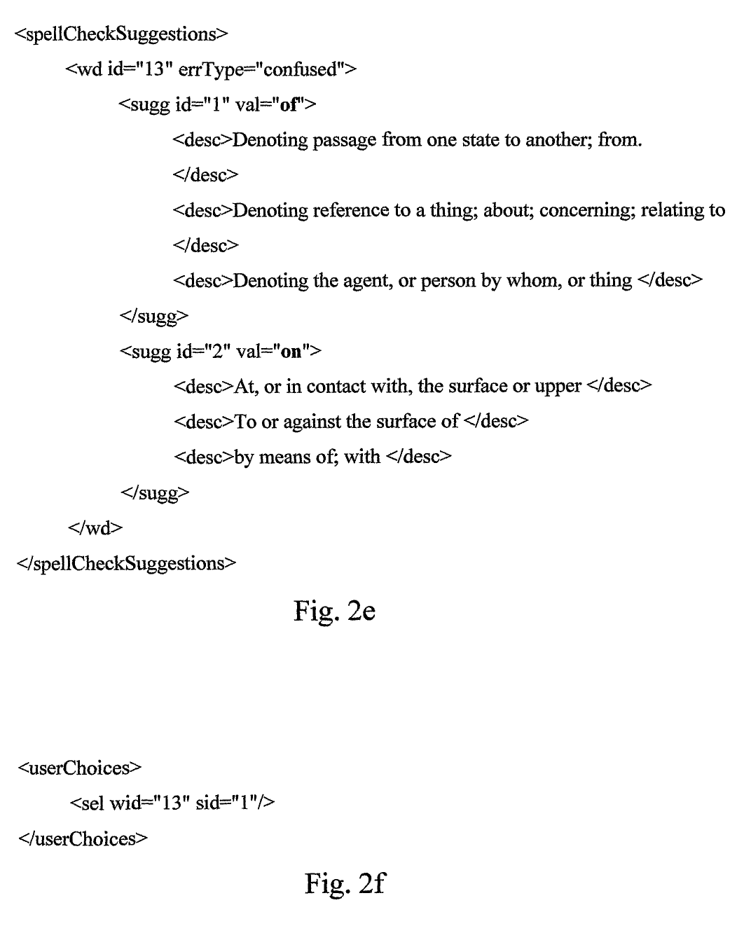

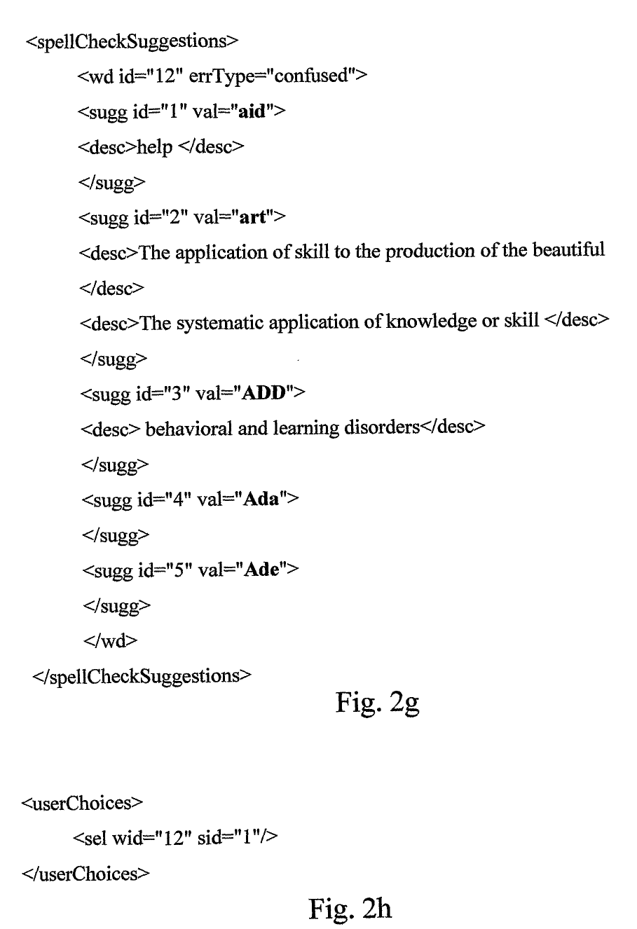

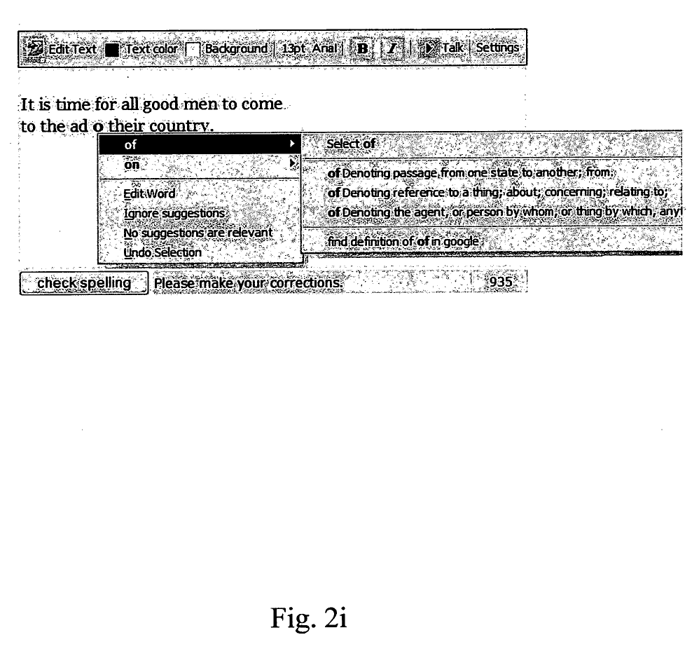

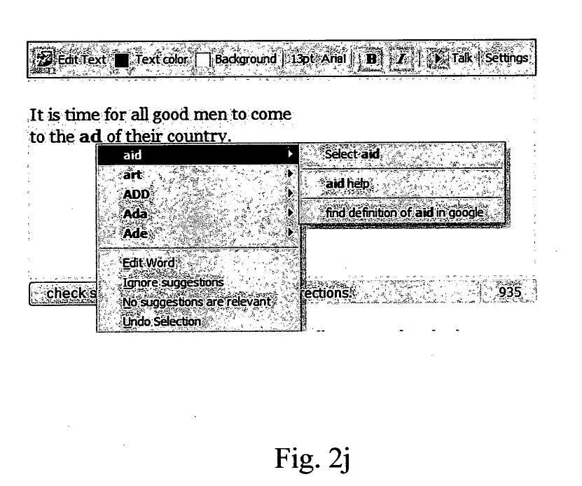

The following abbreviations are used in samples of XML code at FIG. 1 and FIG. 2.
wd—word;
wid—word id;
ign—ignore;
sel—selected alternative;
sid—selected alternative id;
sugg—suggested alternative;
desc—description or usage example phrase
sep—separator like dot, comma, etc
FIG. 1 is a correction example for the phrase: “Meat u at sevn occk.”, where the following is shown at:

a) the first iteration XML encoding of the phrase passed to the context spelling method;

b) the first iteration XML code with the detected words-in-question with the proposed by the context spelling method correction alternatives and their descriptions;

c) the first iteration XML code with user's decisions made;

d) the second iteration XML code with the detected words-in-question with the proposed by the context spelling method correction alternatives and their descriptions;

e) the second iteration XML code with user's decisions made;

f) the end of iterations XML code notification;

FIG. 2 is a correction example for the phrase: “It is tim for all goo men to come to the ad o there counttry.”,
where the following is shown at:

a) the first iteration XML encoding of the phrase passed to the context spelling method;

b) the first iteration XML code with the detected words-in-question with the proposed by the context spelling method correction alternatives and their descriptions;

c) the first iteration user-seen system-user interface presentation with selection menu;

d) the first iteration XML code with user decisions made;

e) the second iteration XML code with the detected words-in-question with the proposed by the context spelling method correction alternatives and their descriptions;

f) the second iteration XML code with user decisions made;

g) the third iteration XML code with the detected words-in-question with the proposed by the context spelling method correction alternatives and their descriptions;

h) the third iteration XML code with user decisions made;

i) the second (upper menu) and the third (down menu) iteration user-seen system-user interface presentation with selection menu;

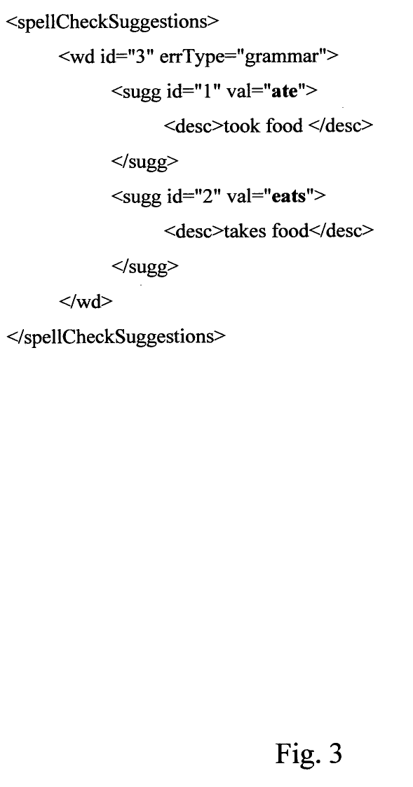

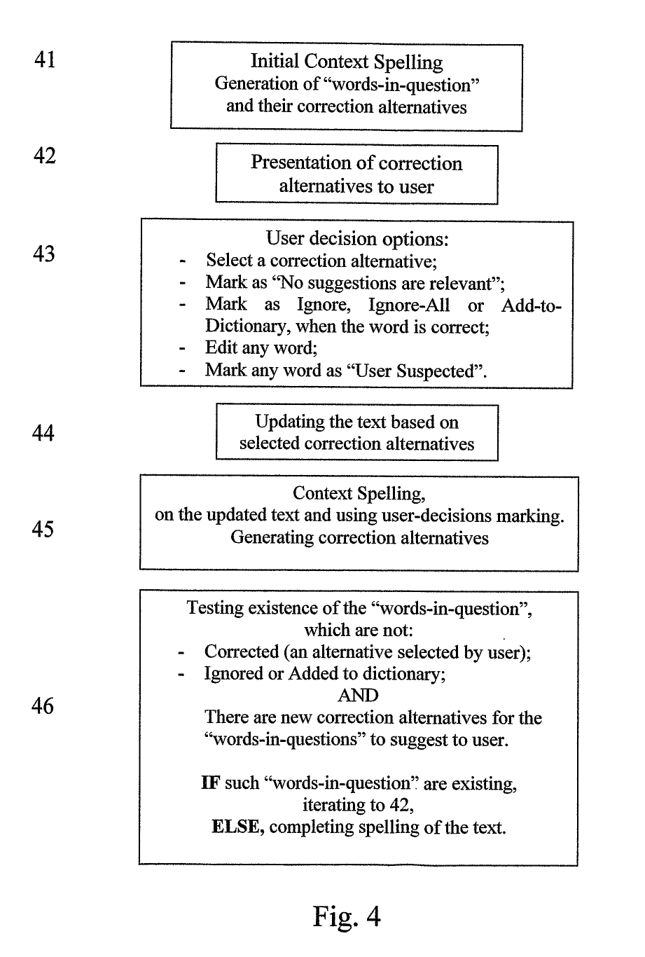

FIG. 3 depicts XML-code containing detected confused word with a grammar error, correcting the phrase: “The cat eat a mouse.” The XML marks such confused word as “grammar” with the correction alternatives “ate” and “eats”.
FIG. 4 depicts the interactive iterative sequence of the invention. Step 41 analyses a text, runs context spelling method and detects the “words-in-question” with correction alternatives presented to user at step 42. User makes decisions at step 43, where the decisions are used to correct the text and status of the “words-in-question” at step 44. The updated analyzed text passed to context spelling method at step 45, where the spelling correction alternatives are generated. Step 46 will analyze the “words-in-question” newly generated alternatives. If there is at least a single not-corrected “word-in-question” with a new correction alternative/s, the system will make the next iteration to the step 42. If no such words are found, the spelling of the text is completed.

1-8. (canceled)

9. A method for correction of misspelled or confused words in a sentence comprising:
Detecting a word in the sentence suspected as misspelled or confused;
Generating and presenting to a user a set of one or more correction alternatives for the detected word along with an option of requiring correction alternatives other than said one or more correction alternatives;
Receiving the user's input indicating the option of requiring correction alternatives other than the one or more correction alternatives; and
Regenerating and presenting to the user another set of one or more other correction alternatives, wherein said other correction alternatives are at least partially based on the intended context of the sentence as associated with the user not choosing an appropriate correction from within the presented one or more correction alternatives.

10. The method according to claim 9 wherein receiving the user's input further comprises receiving a user indication of one or more words, not detected as suspected misspelled or confused words, for which the user would like to receive correction alternatives.

11. The method according to claim 9 wherein receiving the user's input further comprises receiving a user indication of one or more words, detected as suspected misspelled words, as being correctly spelled.

12. The method according to claim 11 further comprising adding the suspected misspelled words, indicated by the user as being correctly spelled, to a user's personal dictionary of correctly spelled words.

13. The method according to claim 9 wherein receiving the user's input further comprises receiving a user indication of one or more words, detected as suspected confused words, as not being confused words.

14. The method according to claim 9 wherein the correction alternatives presented to the user are accompanied by explanations of said correction alternatives' meanings and/or examples of their usage.

15. The method according to claim 9 wherein presenting to the user and receiving input from the user is performed through a user interface type selected from a set comprising: a console application interface, a graphic application interface, a web-browser embedded interface, a word processor embedded interface, a command line interface, a published set of APIs and/or a mobile device application.

16. The method according to claim 11 wherein regenerating and presenting to the user another set of one or more other correction alternatives is repeated until all words detected as suspected misspelled or confused words are corrected or indicated by the user as correctly spelled.

17. The method according to claim 9 wherein regenerating and presenting to the user another set of one or more other correction alternatives is repeated until a pre-defined threshold number of correction alternatives regenerations is reached.

18. A System for correction of misspelled or confused words in a sentence comprising:
A processing logic adapted to detect a word in the sentence suspected as misspelled or confused, and to generate a set of one or more correction alternatives for the detected word;
A user interface adapted to present to a user the set of the one or more correction alternatives for the detected word along with an option of requiring correction alternatives other than said one or more correction alternatives, and to receive the user's input indicating the option of requiring correction alternatives other than the one or more correction alternatives; and
Wherein the processing logic is further adapted to regenerate another set of one or more other correction alternatives, at least partially based on the intended context of the sentence as associated with the user not choosing an appropriate correction from within the presented one or more correction alternatives, and
the user interface is further adapted to present to the user said set of one or more other correction alternatives.

19. The system according to claim 18 wherein the user interface is further adapted to receive a user indication of one or more words, not detected as suspected misspelled or confused words, for which the user would like to receive correction alternatives.

20. The system according to claim 18 wherein the user interface is further adapted to receive a user indication of one or more words, detected as suspected misspelled words, as being correctly spelled.

21. The system according to claim 20 wherein the processing logic is further adapted to add the suspected misspelled words, indicated by the user as being correctly spelled, to a user's personal dictionary of correctly spelled words.

22. The system according to claim 18 wherein the user interface is further adapted to receive a user indication of one or more words, detected as suspected confused words, as not being confused words.

23. The system according to claim 18 wherein the user interface is further adapted to accompany the correction alternatives presented to the user with explanations of said correction alternatives' meanings and/or examples of their usage.

24. The system according to claim 18 wherein the user interface type is selected from a set comprising: a console application interface, a graphic application interface, a web-browser embedded interface, a word processor embedded interface, a command line interface, a published set of APIs and/or a mobile device application.

25. The system according to claim 20 wherein the processing logic and the user interface are further adapted to, respectively, repeatedly regenerate and present to the user another set of one or more other correction alternatives, until all words detected as suspected misspelled or confused words are corrected or indicated by the user as correctly spelled.

26. The system according to claim 18 wherein the processing logic and the user interface are further adapted to, respectively, repeatedly regenerate and present to the user another set of one or more other correction alternatives, until a pre-defined threshold number of correction alternatives regenerations is reached.
